(19) United States
(12) Patent Application Publication
(10) Pub. No.: US 2017/0146036 A1
(43) Pub. Date: May 25, 2017

(54) VALVE MODULAR SYSTEM

(71) Applicant: HYDAC FLUIDTECHNIK GMBH, Sulzbach/Saar (DE)

(72) Inventors: Andreas BOEHLER, Saarbruecken (DE); Arkadiusz PLOTKA, Merzig (DE)

(21) Appl. No.: 15/323,476

(22) PCT Filed: Jun. 26, 2015
(86) PCT No.: PCT/EP2015/001287

§ 371 Date: Jan. 3, 2017

(30) Foreign Application Priority Data
Jul. 5, 2014 (DE) 10 2014 009 996.2

(51) Int. Cl. F15B 13/08

(52) U.S. Cl. CPC F15B 13/0892; F15B 13/0817; F15B 13/0832; F15B 13/0821; F15B 2013/006

(57) ABSTRACT

A valve modular system, comprising individual block components (1 to 4), each of which has a plurality of emerging connection points on at least one part of the free end faces thereof, for the purpose of holding connection components, such as insert valves (29, 35), pressure balances, nozzle or screen inserts (43), fluid lines, blind plugs (13, 15), pressure and temperature displays, hydraulic accumulators (9) and comparable fluid-influencing or fluid-evaluating or fluid-storing components, and which abut each other with the adjacent end faces (11) thereof in a longitudinal direction, in pairs, to form a longitudinal linkage and in this respect are connected at least partially to each other in a fluid-guiding manner, is characterised in that transversely to the longitudinal linkage at least one further block component (45, 49, 51, 59) is placed on at least one of the other block components (1 to 4) to form a vertical linkage in a fluid-guiding manner.

The invention concerns a modular valve system comprised of individual block components, each of which has a plurality of connection points that exit from at least one part of the free end faces thereof, for the purpose of accommodating attachment components such as insert valves, pressure compensators, nozzle or orifice inserts, fluid lines, blind plugs, pressure and temperature gauges, hydraulic accumulators and matchable fluid-influencing or fluid-evaluating or fluid-storing components, and which abut each other with their adjacent end faces in pairs in a longitudinal direction to form a longitudinal chain, and in this respect are connected to each other at least partially in a fluid-conducting manner.

Modular systems of this kind are prior art (DE 10 2013 008 841) and are used in industrial plants that are equipped with hydraulic systems in which the hydraulic operation of actuators for control and/or work functions is provided. There are many areas of application, some of which are, for example, in machine tools for spindle clamping, spindle brake or clutches, or on lathes for chuck tightening, as well as carrying out operations in mobile plant such as cranes, forklifts or on vehicle lifts. In applications such as these a larger number of block components is usually required for a corresponding number of valves and other hydraulic components. In order to limit the required physical size it is therefore advantageous to arrange module-like block components, which have connection points as well as attachments for hydraulic components, in a longitudinal chain abutting each other whilst forming mutual fluid connections, which makes it possible not only to provide a space-saving design but also to limit the amount of external pipe connections.

Despite the advantages achieved in this respect, the compactness for applications in plants where complex control and operating functions need to be carried out, which therefore require a larger number of block components, leaves much to be desired.

Based on this prior art it is the object of the invention to further develop a modular valve system of the kind described at the outset in such a manner that a particularly compact design is also achievable with an increased number of required components.

According to the invention this object is met by a modular valve system that bears the characteristics of claim 1 in their entirety.

Thus, one significant feature of the invention is that, transverse to the longitudinal chain, at least one further block component is placed, fluid-conducting, on top of at least one of the other block components and thus forming a vertical chain. At a given physical length, which is limited by the size of the available installation space, it is possible to house a larger number of components in the system without requiring additional external pipe connections. The modular system according to the invention may therefore be utilized with particular advantage in plants that have limited installation space available such as, for example, mobile equipment like cranes, forklifts, construction machinery and such like.

Particularly advantageously the arrangement may be such that the respective further block component in the vertical chain is provided with further connection points on its respective free end face to accommodate further attachment components, which have a design that matches the attachment components of the longitudinal block component chain. It is thus possible to place on top of a bottom-level first longitudinal chain, a further partial or full longitudinal chain, as it were a second storey, which can provide optimal space utilisation.

In a particularly advantageous embodiment of the modular valve system according to the invention it is provided that the majority of the block components used in the system, preferably all block components, are able to perform an autonomous, hydraulic function also outside the system by themselves, like functional cuboids, without having to be connected to further block components in a system of longitudinal and/or vertical chains. Thus one hydraulic block component by itself may, for example, be responsible for the positioning of the tailstock of a machine tool, another function block could be taking care of the “steady rest” function, another function block again may look after the main pressure and counter pressure tensioning when machining thin-walled material, and another block component again may be tasked with gripping the components produced by the machine tool from a chuck or such like. Thus, depending on the application of the machine tool, only one or the other block component may be employed; however, if required, all block components may be connected together in longitudinal and vertical chain direction and be used as a unit for a machine tool.

Moreover, the above described block components may be used outside the application sector of machine tools directly for other applications, for example in cooling and blower devices and heat exchanger facilities. This is not possible with the known chain arrangements of the prior art. Although they assemble individual block components as functional cuboids, the individual block components by themselves in isolation are not able to undertake a hydraulic function, only always in conjunction with other block components.

In a particularly preferred embodiment of the modular valve system according to the invention it is provided that the majority of the functional cuboid-like block components, preferably all block components, used in the system are provided with sealed connection points to provide a fluid-conducting connection with the adjacent block components, which may be able to be connected to each other by means of screw connectors into blocks also in longitudinal direction. Whilst in known chain systems tie rods are sometimes used that pass through all block components in the respective chain direction in order to secure them to each other, the solution according to the invention provides for an attachment of each block component to the next adjacent component individually via a screw connection. Thus it is possible to add any number of block components in all directions in the longitudinal and vertical chain and, if required, remove it again from the valve system. This is unknown in the prior art.

Each function module can therefore be used as a block component in itself as well as in a chain in vertical and horizontal direction. The sequence aimed for is guided by the task of the control system as well as by the fitting of the modules with pressure valves, flow control valves, non-return valves and directional valves. The system therefore provides individual possibilities for expansion and replacement in every direction that is very easy to accomplish from a design point of view. If required, block components may be added or removed in every direction of a chain level.

The modules of the vertical/longitudinal chain thus permit a flow-optimised, flexible and expandable control module characteristic. A compact assembly is achieved in that only one so-called Cetop valve is necessary compared to the conventional sub-plate mounting solution; all other valves are integrated in the housing as cartridge designs. Further flexibility is achieved in that the respective block component can be connected on both sides.

The block components in longitudinal chain may advantageously form individual functional cuboids which, seen in longitudinal chain direction, may have varying installation lengths, and their rectangular, preferably square, end faces are flat and have the same circumferential dimensions. The entire longitudinal chain thus forms a uniform block with rectangular plan view and flush, abutting lateral surfaces.

In particularly advantageous exemplary embodiments the further block components are assigned to a defined, individual functional cuboid of the longitudinal chain and form further functional cuboids, the connection layout of which matches the connection layout of the assignable functional cuboid of the longitudinal chain. Moreover, the further functional cuboids with their installation dimensions in longitudinal chain direction are able to connect to the functional cuboids of the longitudinal chain without protruding.

In an assembly variation of the modular system it is possible that at least some of the further functional cuboids are placed transverse to the longitudinal and vertical chain direction and protrude with their installation dimensions over the functional cuboids of the longitudinal chain. In a further variation to achieve a compact installation size with an increased number of components, the arrangement may advantageously be such that a plurality of further functional cuboids are arranged one above the other, seen in vertical chain direction, forming a functional tower. Such an arrangement is particularly advantageous if the available installation space is limited in length but is sufficiently high. In exemplary embodiments of this kind it is possible to arrange further third functional cuboids on the functional tower so that they protrude laterally, seen transverse to the tower direction.

In the system according to the invention it is possible to connect, for average fluid control tasks, up to ten functional cuboids in longitudinal chain direction and vertical chain direction, at nominal flow rates up to 200 l/min, preferably of approximately 80 l/min, and working pressures of up to 300 bar, preferably of approximately 210 bar.

The fluid connection points of the different functional cuboids on each of the free connection sides in longitudinal and vertical chain direction may be sealed to the environment through at least one sealing means, for example by way of a blind plug.

In a particularly advantageous manner the functional cuboids in the longitudinal chain could leave an end face free of attachment components in such a way that a uniform, flat mounting surface is formed for the purpose of connecting the modular valve system to third components, such as protective housings in machine tools and other machines, where the latter may also be mobile machines. The system according to the invention can thus be integrated into a respective on-site hydraulic system without installing pipe connections.

The invention is now described in more detail by way of exemplary embodiments depicted in the drawing. Shown are in:

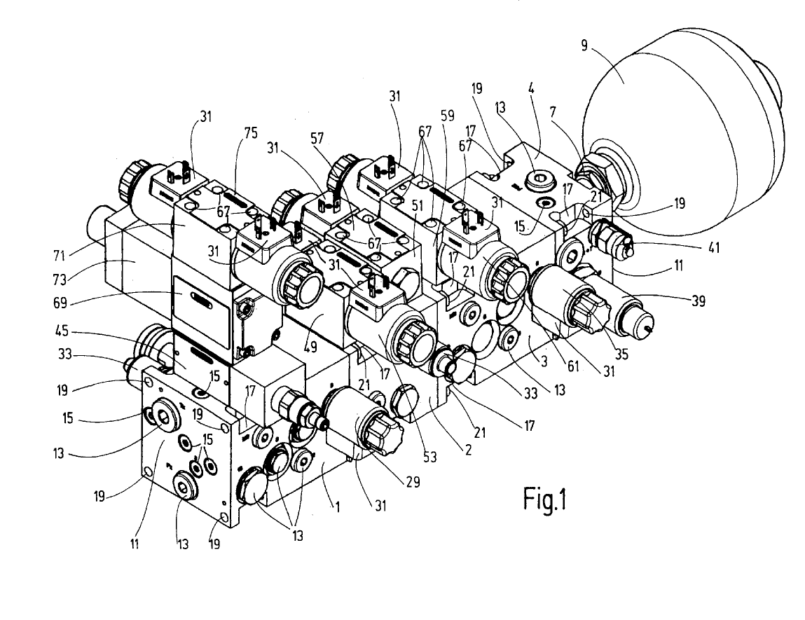

FIG. 1 a perspective view of an exemplary embodiment of the modular valve system according to the invention;

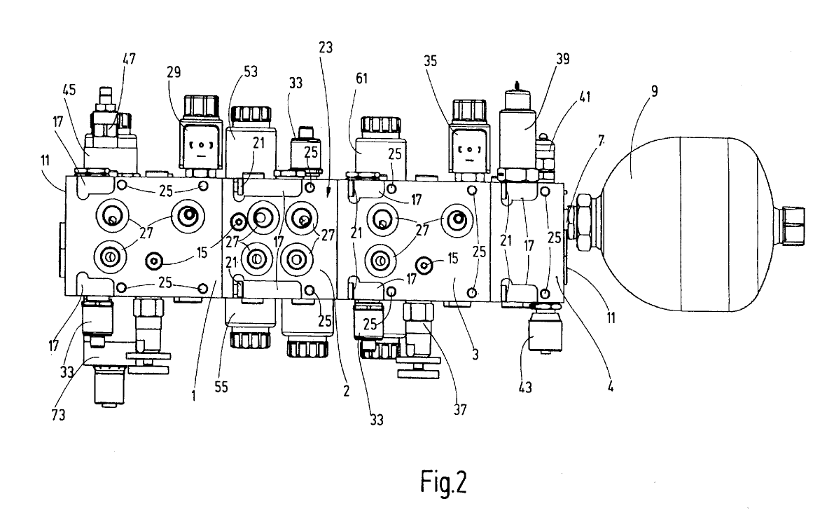

FIG. 2 a view from below of the exemplary embodiment of FIG. 1, and

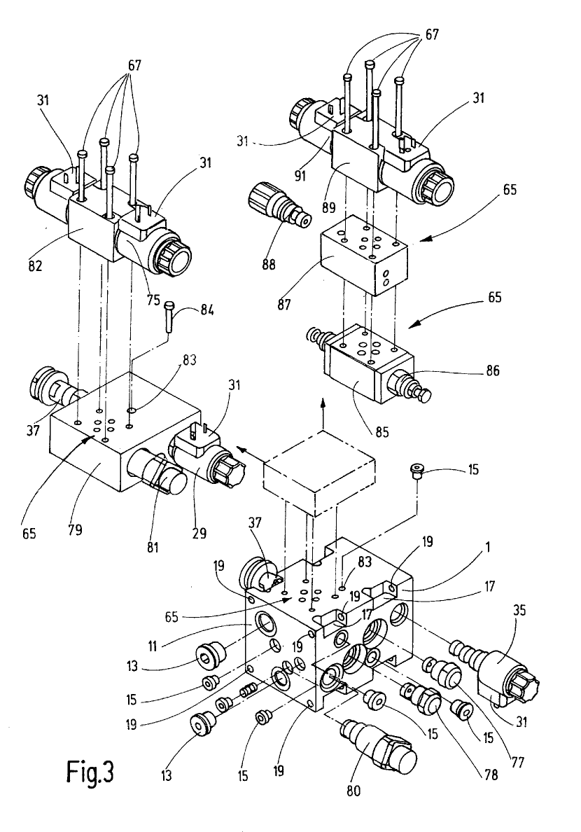

FIG. 3 a perspective and exploded view of individual components of further exemplary embodiments of the modular valve system according to the invention.

The exemplary embodiment of the modular valve system according to the invention shown in FIGS. 1 and 2 is based on block components that are arranged in a longitudinal chain without gap, abutting each other, and which are shown in the drawing in succession starting from the left end, designated with the numbers 1 to 4.

The right-hand, outer block component 4 is an accumulator module that takes the form of a hydraulic accumulator 9 that is connected to a connection point 7 at the free end face 11. Each of the block components 1 to 4 takes the form of a functional cuboid with flat, rectangular lateral surfaces. In the example shown, the end faces 11 of the functional cuboids in longitudinal chain direction have a square outline. To establish the fluid connections between the block components 1 to 4 to each other, connection points are formed in the end faces 11, which are located in a position that matches the connection layout, and which are sealed at the free end faces by way of plugs 13, as is also the case for free borehole ends that are sealed with blind plugs 15. Not all plugs 13 and blind plugs 15 are numbered to keep the drawing uncluttered.

Located in each of the edge regions of the block components 1 to 4 are recesses in form of pockets 17 that are provided with mounting holes 19 so as to attach the block components 1 to 4 to each other by means of mounting screws 21. The base surface that is apparent from FIG. 2 and which is formed by the longitudinal chain of the block components 1 to 4 remains free of attachment components and thus forms a flat attachment side 23 with which the modular system may be mounted by means of mounting boreholes 25 in a respective plant (not shown). Sealed fluid connections to the respective plant are formed via user connections 27.

On both lateral surfaces, which are adjacent to the bottom attachment side 23, the block components 1 to 4 are provided with the connection points for the respective attachment components. The block component 1 is in this respect provided with a 3/2-way valve 29 with solenoid connection 31 and a pressure sensor 33. The block component 2 is also provided with a pressure sensor 33. The further block component 3 is provided with a 3/2-way valve 35 with a solenoid connection 31, a further pressure sensor 33 as well as a pressure control valve 37. The final block component 4 is, apart from the hydraulic accumulator 9, provided with a measuring connection 41 as well as an adjustable orifice 43.

As can be seen most clearly from FIG. 1, located on top of the longitudinal chain formed by the block components 1 to 4 is a vertical chain with additional block components that also form rectangular-shaped functional cuboids which, in the example shown, have sizes that deviate from the dimensions of the block components 1 to 4. Here a functional cuboid 45 that is assigned to the block component 1 is disposed so that it protrudes from the lateral surface of the block component 1, which is shown in front in FIG. 1; said functional cuboid 45 is provided with a pressure control valve 47. Two functional cuboids 49 and 51, which are part of the vertical chain, are assigned to the subsequent block component 2. Of these, the functional cuboid 49 is provided with two 4/2-way valves 53 and 55 with a solenoid connection 31 each. The functional cuboid 51 is provided with a 4/2-way valve 57 with a solenoid connection 31. Located on block component 3 as part of the formed vertical chain is a further functional cuboid 59, which is provided with a 4/3-way valve 61 with manual override and solenoid connections 31.

As is apparent from FIG. 3, in which the block component 1 is shown in connection with components of two further exemplary embodiments, which are discussed later, the block component 1 is provided with a connection layout 65 with nine openings for the attachment of functional cuboids that are disposed above and form a vertical chain, as is the case for block components 2 and 3. The functional cuboids 49, 51 and 59, which form the vertical chain, are provided on the underside (not visible in FIGS. 1 and 2) with a corresponding connection layout for screw connections as well as fluid connections for the purpose of creating the hydraulic circuit of the longitudinal and vertical chains. As can also be seen in FIG. 3, four bore holes of the connection layout 65 serve for the attachment of the components of the vertical chain by means of mounting screws 67.

For the formation of a kind of functional tower, a functional cuboid 69 and an above located functional cuboid 71 are disposed as second and third step respectively of the vertical chain above the functional cuboid 45 in the exemplary embodiment shown in FIG. 1. Of these the functional cuboid 69 is provided with an orifice device 73, which comprises an adjustable orifice, a fixed orifice and a non-return valve. As shown in FIGS. 1 and 2, the orifice device 73 projects beyond the in FIG. 1 inner side of the longitudinal chain. The above-located functional cuboid 71 is, in the example shown, provided with a 4/3-way valve 75 with manual override and solenoid connections 31.

The FIG. 3 depicts exemplary embodiments that correspond with two variations of a functional tower construction, each of which is assembled on the same block component 1 of the longitudinal chain. In both variations the block component 1 is sealed at the free end face 11 through plugs 13 and blind plugs 15 to the environment, as is also shown in the example of FIG. 1. The attachment components disposed on the front end face are a 3/2-way valve 35 with solenoid connection 31, non-return valves 77 and 78, a blind plug 15 and a 2/2-way valve. A pressure control valve 37 is provided on the opposite lateral side. The variation depicted on the left side in FIG. 3 shows on the flat upper side of the block component 1 a functional cuboid 79 with through holes, which correspond to the connection layout 65, and a square base surface that fully covers the flat upper side of the block component. The functional cuboid 79 comprises a pressure control valve 37, a 2/2-way valve and a 3/2-way valve 29 with solenoid connection 31. A functional cuboid 82 with a connection layout 65 on its underside is arranged on the functional cuboid 79 as the uppermost step of the functional tower, where mounting screws 67 pass through bore holes of connection layout 65. The attachment component of functional cuboid 82 is a 4/3-way valve 75 with manual override and solenoid connections 31. Since the functional cuboid 82, as depicted, does not have a square base surface but a smaller rectangular one compared to functional cuboid 79, one opening 83 of the connection layout 65 remains open when the connection is made and must be sealed with a screw 84.

The design variation depicted on the right-hand side in FIG. 3 provides on the block component 1 for a functional cuboid 85, the outline of which conforms to the functional cuboid 82 of the variation shown on the left so that again an opening 83 of the connection layout 65 remains open and must be sealed with a blind plug 15. The functional cuboid 85, which also features the connection layout 65, has a spool valve 86 as attachment component. Arranged above the functional cuboid 85 is an intermediate plate 87, the plan view of which corresponds to that of the functional cuboid 85 and to which an adjustable nozzle insert 88 is attached.

As the uppermost step of the functional tower, a further functional cuboid 89 is provided, the underside of which also features the connection layout 65 that has holes on the upper side where the mounting screws 67 pass through. The attachment component on the uppermost functional cuboid 89 is a 4/3-way valve with solenoid connections 31 and manual override.

As a result of the vertical chain provided above the longitudinal chain it is possible to provide functional towers with multiple vertical steps for an installation space with limited installation length so as to be able to house a larger number of attachment components than would be possible by just a longitudinal chain of block components. A particularly compact size of the system according to the invention is also achieved in that the block components 1 to 4 are arranged in the longitudinal chain without gaps and therefore butt up against each other as tightly as possible. As has been demonstrated, the assembly variations can be adapted depending on the condition of the available installation space, thus making it possible to realise the optimal assembly variation for each case.

1. The invention concerns a modular valve system comprised of individual block components (1 to 4), each of which has a plurality of connection points that exit from at least one part of the free end faces thereof, for the purpose of accommodating attachment components such as insert valves (29, 35), pressure compensators, nozzle or orifice inserts (43), fluid lines, blind plugs (13, 15), pressure and temperature gauges, hydraulic accumulators (9) and matchable fluid-influencing or fluid-evaluating or fluid-storing components, and which abut each other with their adjacent end faces (11) in pairs in a longitudinal direction to form a longitudinal chain, and in this respect are connected to each other at least partially in a fluid-conducting manner, characterised in that transverse to the longitudinal chain, at least one further block component (45, 49, 51, 59) is placed, fluid-conducting, on top of at least one of the other block component (1 to 4) and thus forming a vertical chain.

2. Modular valve system according to claim 1, characterised in that the respective further block component in the vertical chain (45, 49, 51, 59) is provided with further connection points on its respective free end face to accommodate further attachment components, which have a design that matches the attachment components of the longitudinal block component chain (1 to 4).

3. Modular valve system according to claim 1, characterised in that the block components in the longitudinal chain form individual functional cuboids (1 to 4) which, seen in longitudinal chain direction, may have varying installation lengths, and their rectangular or square end faces are flat and have the same circumferential dimensions.

4. Modular valve system according to claim 1, characterised in that the majority of the block components used in the system, preferably all block components, are able to perform an autonomous, hydraulic function also outside the system by themselves, like functional cuboids, without having to be connected to further block components of the system in longitudinal and/or vertical chain direction.

5. Modular valve system according to claim 1, characterised in that the majority of the functional cuboid-like block components, preferably all block components, used in the system are provided with sealed connection points to provide a fluid-conducting connection with the adjacent block components, which may be able to be connected to each other individually by means of individual screw connections also in longitudinal direction.

6. Modular valve system according to claim 1, characterised in that the further block components are assigned to a defined, individual functional cuboid (1, 2 or 3) of the longitudinal chain and form further functional cuboids (45, 49, 51, 59), the connection layout (65) of which matches the connection layout (65) of the assignable functional cuboid (1, 2 or 3) of the longitudinal chain.

7. Modular valve system according to claim 1, characterised in that the further functional cuboids (45, 49, 51, 59) with their installation dimensions in longitudinal chain direction are able to connect to the functional cuboids (1, 2 or 3) of the longitudinal chain without protruding.

8. Modular valve system according to claim 1, characterised in that at least some of the further functional cuboids (45, 49, 51, 59) are placed transverse to the longitudinal and vertical chain direction and protrude with their installation dimensions over the functional cuboids (1, 2 or 3) of the longitudinal chain.

9. Modular valve system according to claim 1, characterised in that a plurality of further functional cuboids (69, 79, 82, 85, 87, 89) are arranged one above the other, seen in vertical chain direction, forming a functional tower.

10. Modular valve system according to claim 1, characterised in that further third functional cuboids (69) are arranged on the functional tower so that they protrude laterally, seen transverse to the tower direction.

11. Modular valve system according to claim 1, characterised in that, for average fluid control tasks, up to ten functional cuboids in longitudinal chain direction and vertical chain direction are connected at nominal flow rates up to 200 l/min, preferably of approximately 80 l/min, and working pressures of up to 300 bar, preferably of approximately 210 bar.

12. Modular valve system according to claim 1, characterised in that the fluid connection points of the different functional cuboids on the free connection sides in longitudinal and vertical chain direction are sealed to the environment through at least one sealing means (13, 15).

13. Modular valve system according to claim 1, characterised in that the functional cuboids (1 to 4) in the longitudinal chain leave an end face free of attachment components in such a way that a uniform, flat mounting surface (23) is formed for the purpose of connecting the modular valve system to third components, such as protective housings in machine tools and other machines, where the latter may also be mobile machines.
